(19) United States
(12) Patent Application Publication
(10) Pub. No.: US 2014/0072814 A1
(43) Pub. Date: Mar. 13, 2014

(54) SELF-DISINFECTING TABLEWARE AND METHOD FOR MANUFACTURING THE SAME

(71) Applicant: Jianfeng ZHUGE, Dongguan City (CN)

(72) Inventor: Jianfeng ZHUGE, Dongguan City (CN)

(21) Appl. No.: 13/607,922

(22) Filed: Sep. 10, 2012

(51) Int. Cl. B32B 9/04; B29C 43/20

(52) U.S. Cl. 428/446; 428/688; 264/113

(57) ABSTRACT

The disclosure discloses self-disinfecting tableware, which comprises a tableware body, wherein the surface of the tableware body is attached with a glazing powder layer and the glazing powder layer contains an antibacterial substance. The self-disinfecting tableware of the disclosure has an advantage of performing automatic bacteria disinfection and sterilization on the surface of the tableware through the antibacterial agent which, together with the glazing powder, is attached on the internal surface of the tableware body or on the internal and external surfaces of the tableware body. This sterilization and disinfection mode is odourless and non-toxic, heat-resistant, and pollution-free and guarantees the sanitization of dinning. Compared with the conventional art, the antibacterial substance needed by the glazing powder layer is relatively less than that needed by the tableware body; the reduction of antibacterial substance can lower the cost, save material and is more environment-friendly.

### TECHNICAL FIELD OF THE INVENTION

The disclosure relates to self-disinfecting tableware and further to a method for manufacturing the tableware, both of which belong to the technical field of tableware.

### BACKGROUND OF THE INVENTION

In the conventional art, in order to guarantee the sanitation of dinning, people often disinfect tableware, however, this disinfection mode is passive and needs to be completed by means of tools, manual labour and disinfectant, and the cleaning agent used would cause pollution to environment; if the disinfection condition is poor or the operator is irresponsible, the disinfection of the tableware can not meet the standard of the sanitation of tableware, and the risk of infectious disease is increased when this tableware is used.

A Chinese patent document CN201767612U discloses melamine tableware, which comprises a body, wherein the body is manufactured into a scheduled shape by heated injection molding and comprises a base material portion which is made from melamine base materials and nano powder which is uniformly blended in the base material portion. The melamine tableware can play the antibacterial effect through the antibacterial effect of nano after the melamine base materials and the nano powder are uniformly mixed to be made into the body in a suitable proportion.

A Chinese patent document CN201691549U discloses melamine with antibiotic effect, which comprises a body and a utility layer uniformly blended in the inside of the body, wherein the utility layer is formed by an antibacterial agent. The body is manufactured into a scheduled shape by heated injection molding and comprises a base material portion which is made from melamine base materials and an antibacterial agent which is uniformly blended in the base material portion. The antibacterial agent can be an inorganic antimicrobial agent, an organic antimicrobial agent or a metal oxide antimicrobial agent. After the melamine substrate and one of the above antimicrobial agents are mixed to be made into the body, different antibiotic effects can be exerted by means of different antibiotic actions of each antimicrobial agent.

For both the above two products, an antibacterial substance is added in the base material portion (body); it is all known that, to make the product achieve a stable antibacterial effect, the antibacterial substance added in the product must be uniform and of a certain percentage, that is, the base material portion (body) must contain a certain percentage of antibacterial substance, namely, the heavier the base material portion (body) is, the more the antibacterial substance contained in the product is. Since the base material portion (body) generally has a relatively big mass, the antibacterial substance needing to be added in the tableware above is of a great amount; thus, the cost needed is high.

### SUMMARY OF THE INVENTION

The technical problem needing to be solved in the disclosure is to provide self-disinfecting tableware, which needs less antibacterial substance, can lower cost, save material and is good for environment.

The disclosure also provides a method for manufacturing the self-disinfecting tableware.

The self-disinfecting tableware of the disclosure may adopt the technical solution as follows.

Self-disinfecting tableware comprises a tableware body, wherein the surface of the tableware body is attached with a glazing powder layer and the glazing powder layer contains an antibacterial substance;

in which, the glazing powder is also called overlay resin moulding powder, and the molecular structure is similar to that of melamine formaldehyde resin powder; both of the glazing powder and the melamine formaldehyde resin powder belong to a polymer compound; the melamine formaldehyde resin powder is obtained by drying and ball-milling the resin which is obtained by reacting formaldehyde with melamine; since no pulp is added, it is commonly called flavour powder; when tableware is pressed, some powder is spread on the surface to increase the brightness of the product and make the product more beautiful; meanwhile, this powder can increase the surface hardness of the tableware and prolong the service life of the product.

The disclosure can further adopt the improvement measure as follows to solve the problem.

The internal surface of the tableware body is attached with a glazing powder layer and the glazing powder layer contains an antibacterial substance.

The external surface of the tableware body is attached with a glazing powder layer and the glazing powder layer contains an antibacterial substance.

The antibacterial substance is an antibacterial agent.

The antibacterial agent is an organic antibacterial agent or an inorganic antibacterial agent.

The mass proportion of the glazing powder to the antibacterial substance in the glazing powder layer is 90%-99.9% to 0.1%-10%.

The antibacterial substance is one or a mixture of the following substances: silicon nanometre silver, phosphate antibacterial agent, Munto antibacterial agent and zeolite antibacterial agent.

The antibacterial substance is an inorganic silicate antibacterial agent containing silver ions.

The method for manufacturing the self-disinfecting tableware of the disclosure adopts the technical solution as follows.

The method for manufacturing the self-disinfecting tableware comprises the following steps: 1) preparing materials; 2) putting melamine powder materials on a mould of a hydraulic moulding machine; 3) hot-forming the melamine powder to be made into the tableware body by the hydraulic moulding machine; 4) placing materials of a glazing powder layer on the internal surface of the hot-pressed tableware body, and hot-forming the glazing powder to be attached on the internal surface of the tableware body by the hydraulic moulding machine, to form a glazing powder layer.

Or, the self-disinfecting tableware can adopt the manufacturing method as follows.

The method for manufacturing the self-disinfecting tableware comprises the following steps: 1) preparing materials; 2) putting melamine powder materials on a mould of a hydraulic moulding machine; 3) hot-forming the melamine powder to be made into the tableware body by the hydraulic moulding machine; 4) placing materials of a glazing powder layer on the internal and external surfaces of the hot-pressed tableware body, and hot-forming the glazing powder to be attached on the internal and external surfaces of the tableware body by the hydraulic moulding machine, to form glazing powder layers.

The above technical solution has technical effects as follows.

1. The self-disinfecting tableware of the disclosure has an advantage of performing automatic bacteria disinfection and sterilization on the surface of the tableware through the antibacterial agent which, together with the glazing powder, is attached on the internal surface of the tableware body or on the internal and external surfaces of the tableware body; this sterilization and disinfection mode is odourless and non-toxic, heat-resistant, and pollution-free and guarantees the sanitization of dinning.

2. For the self-disinfecting tableware of the disclosure, the antibacterial substance is contained in the glazing powder layer only and the mass of the glazing powder layer is small relatively to the mass of the tableware body; in the condition that the mass proportion of the antibacterial substance is required to be the same in a substance, compared with the conventional art, the antibacterial substance needed in the glazing powder layer is less than that needed in the tableware body; and the reduction of the antibacterial substance can lower cost, save material and is more environment-friendly.

3. The method for manufacturing the self-disinfecting tableware of the disclosure has a simple process, few steps and is easy to operate.

### BRIEF DESCRIPTION OF THE DRAWINGS

FIG. 1 shows a diagram of the self-disinfecting tableware of the disclosure; and

FIG. 2 shows a diagram of another embodiment of the self-disinfecting tableware of the disclosure.

### DETAILED DESCRIPTION OF THE PREFERRED EMBODIMENTS

The disclosure is described below in detail in conjunction with specific embodiments.

### Embodiment 1

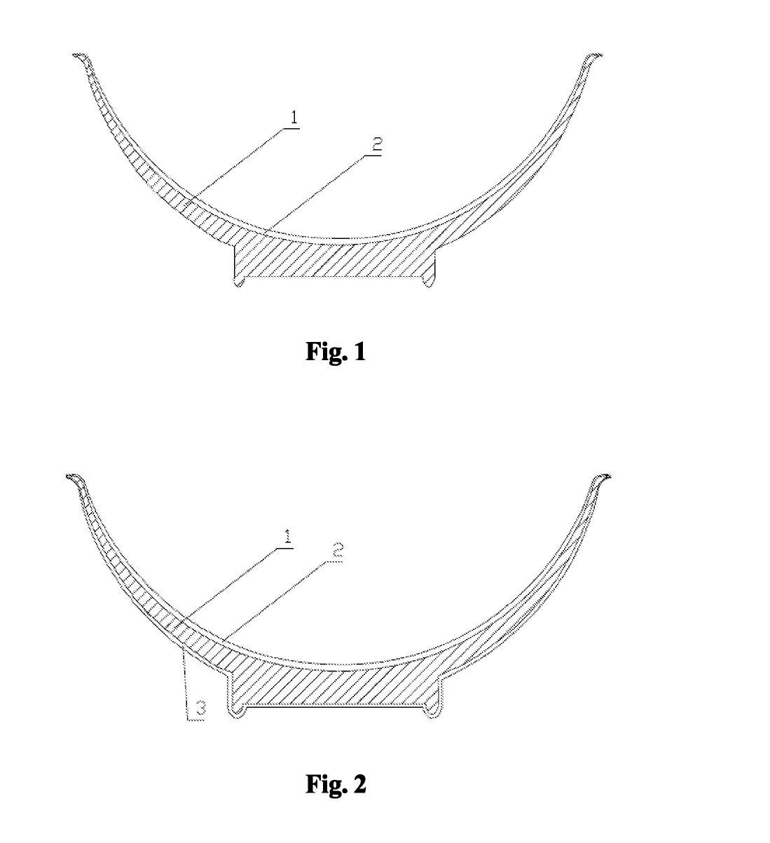

as shown in FIG. 1, self-disinfecting tableware comprises a tableware body 1, wherein the surface of the tableware body is attached with a glazing powder layer 2 and the glazing powder layer contains an antibacterial substance. The antibacterial substance is an antibacterial agent, which specifically is nano-silver.

### Embodiment 2

as shown in FIG. 1, self-disinfecting tableware comprises a tableware body, wherein the internal surface of the tableware body is attached with a glazing powder layer and the glazing powder layer contains an antibacterial substance.

The mass proportion of the glazing powder to the antibacterial substance in the glazing powder layer is 98.5% to 1.5%.

The antibacterial agent is an inorganic antibacterial agent, which specifically is an inorganic silicate antibacterial agent containing silver ions.

In the disclosure, the antibacterial substance is contained in the glazing powder layer only and the mass of the glazing powder layer is small relatively to the mass of the tableware body; in the condition that the mass proportion of the antibacterial substance is required to be the same in a substance, the antibacterial substance needed in the glazing powder layer is less than that needed in the tableware body. Compared with the conventional art, the disclosure reduces the antibacterial substance, lowers cost, saves material and is more environment-friendly.

To compare with the conventional art, on the premise of achieving the same antibacterial effect, in the tableware of the same size, take a plate of 300 g as a sample to perform comparison; when the antibacterial substance is added in the tableware body, 1.5%*300 g*1.5 Yuan/g=6.75 Yuan cost is needed; while the glazing powder only needs 10 g of materials, thus 1.5%*10 g*1.5 Yuan/g=0.225 Yuan cost is needed when the antibacterial substance is added in the glazing powder layer. It is conservatively estimated that 100000 tons of melamine tableware are produced per year globally, if the antibacterial substance is added in the tableware body, 100000 ton*0.015% (antibacterial powder proportion)*1500000 Yuan (antibacterial powder price/per ton)=2.25 billion Yuan cost is needed. If the solution of the disclosure is adopted, only 100000 ton*3% (glazing powder proportion)*0.015 (antibacterial powder proportion)*1500000 Yuan=67.5 million Yuan cost is needed. It can be seen that the disclosure saves cost, reduces material and is good for environment and also achieves the same antibacterial effect; therefore, the product can be used by more people.

Through the experimental comparison, the tableware of the disclosure has effects as follows.

| | 0 h mean | | 24 h mean | | 24 h mean | | |
|---|---|---|---|---|---|---|---|
| | value of | | value of | | value of | | |
| | viable | | viable | | viable | | |
| | bacteria | | bacteria | | bacteria | | |
| | count of | | count of | | count of | | |
| | check | | check | | test | | |
| | sample (per | | sample (per | | sample (per | | Antibacterial |
| Test Strain | CM³) | U0 | CM³) | U1 | CM³) | At | Activity |
| Escherichia Coli | 1.1 × 10⁴ | 4.0 | 4.3 × 10⁴ | 4.6 | 19 | 1.3 | 3.3 |
| Staphylococcus | 9.2 × 10³ | 4.0 | 5.2 × 10³ | 3.7 | <13 | <1.1 | >2.6 |
| aureus | | | | | | | |

The method for manufacturing the self-disinfecting tableware comprises the following steps: 1) preparing materials; 2) putting melamine powder materials on a mould of a hydraulic moulding machine; 3) adjusting the pressure (scope: 20 kg/CM³-220 kg/CM³) and temperature (scope: 150° C.-180° C.) of the hydraulic moulding machine; then hot-forming the melamine powder to be made into the tableware body by the hydraulic moulding machine; 4) placing materials of a glazing powder layer on the internal surface of the hot-pressed tableware body, adjusting the pressure (scope: 20 kg/CM³-220 kg/CM³) and temperature (scope: 150° C.-180° C.) of the hydraulic moulding machine; then hot-forming the glazing powder to be attached on the internal surface of the tableware body by the hydraulic moulding machine, to form a glazing powder layer. The manufacturing method has a simple process, few steps and is easy to operate.

### Embodiment 3

the feature of this embodiment lies in that the mass proportion of the glazing powder to the antibacterial substance in the glazing powder layer is 98.5%-1.5%. The rest is the same as Embodiment 1.

### Embodiment 4

the feature of this embodiment lies in that the mass proportion of the glazing powder to the antibacterial substance in the glazing powder layer is 98%-2%. The rest is the same as Embodiment 1.

### Embodiment 5

as shown in FIG. 2, the internal and external surfaces of the tableware body are attached with a glazing powder layer 2 and a glazing powder layer 3 respectively, and the glazing powder layer contains an antibacterial substance. In this embodiment, both the internal and external surfaces are attached with a glazing powder layer, thus both the internal and external surfaces have an anti-bacterial effect.

The mass proportion of the glazing powder to the antibacterial substance in the glazing powder layer is 90%-99.9% to 0.1%-10%.

The antibacterial substance is an inorganic antibacterial agent, which is an inorganic silicate antibacterial agent containing silver ions.

The method for manufacturing the self-disinfecting tableware comprises the following steps: 1) preparing materials; 2) putting melamine powder materials on a mould of a hydraulic moulding machine; 3) adjusting the pressure (scope: 20 kg/CM³-220 kg/CM³) and temperature (scope: 150° C.-180° C.) of the hydraulic moulding machine; then hot-forming the melamine powder to be made into the tableware body by the hydraulic moulding machine; 4) placing materials of a glazing powder layer on the internal and external surfaces of the hot-pressed tableware body, adjusting the pressure (scope: 20 kg/CM³-220 kg/CM³) and temperature (scope: 150° C.-180° C.) of the hydraulic moulding machine; then hot-forming the glazing powder to be attached on the internal and external surfaces of the tableware body by the hydraulic moulding machine, to form glazing powder layers.

### Embodiment 6

the feature of this embodiment lies in that the antibacterial substance is one or a mixture of the following substances: silicon nanometre silver, phosphate antibacterial agent, Munto antibacterial agent and zeolite antibacterial agent.

### Embodiment 7

the feature of this embodiment lies in that the antibacterial substance also can be an organic antibacterial agent. The rest is the same as Embodiment 1.

The antibacterial agent of the disclosure is a common antibacterial agent.

The above are only the preferred embodiments of the disclosure and are not intended to limit the disclosure. Any modification, equivalent substitute and improvement made within the spirit and principle of the disclosure are deemed to be included within the scope of protection of the disclosure.

What is claimed is:

1. A self-disinfecting tableware, comprising a tableware body, wherein the surface of the tableware body is attached with a glazing powder layer and the glazing powder layer contains an antibacterial substance.

2. The self-disinfecting tableware according to claim 1, wherein the internal surface of the tableware body is attached with a glazing powder layer and the glazing powder layer contains an antibacterial substance.

3. The self-disinfecting tableware according to claim 1, wherein the external surface of the tableware body is attached with a glazing powder layer and the glazing powder layer contains an antibacterial substance.

4. The self-disinfecting tableware according to claim 1, wherein the antibacterial substance is an antibacterial agent.

5. The self-disinfecting tableware according to claim 2, wherein the antibacterial substance is an antibacterial agent.

6. The self-disinfecting tableware according to claim 3, wherein the antibacterial agent is an organic antibacterial agent or an inorganic antibacterial agent.

7. The self-disinfecting tableware according to claim 1, wherein the mass proportion of the glazing powder to the antibacterial substance in the glazing powder layer is 90%-99.9% to 0.1%-10%.

8. The self-disinfecting tableware according to claim 1, wherein the antibacterial substance is one or a mixture of the following substances: silicon nanometre silver, phosphate antibacterial agent, Munto antibacterial agent and zeolite antibacterial agent.

9. The self-disinfecting tableware according to claim 1, wherein the antibacterial substance is an inorganic silicate antibacterial agent containing silver ions.

10. A method for manufacturing self-disinfecting tableware, comprising the following steps:
1) preparing materials;
2) putting melamine powder materials on a mould of a hydraulic moulding machine;
3) hot-forming the melamine powder to be made into the tableware body by the hydraulic moulding machine; and
4) placing materials of a glazing powder layer on the internal surface of the hot-pressed tableware body, and hot-forming the glazing powder to be attached on the internal surface of the tableware body by the hydraulic moulding machine, to form a glazing powder layer.

11. A method for manufacturing self-disinfecting tableware, comprising the following steps:
1) preparing materials;
2) putting melamine powder materials on a mould of a hydraulic moulding machine;
3) hot-forming the melamine powder to be made into the tableware body by the hydraulic moulding machine; and
4) placing materials of a glazing powder layer on the internal and external surfaces of the hot-pressed tableware body, and hot-forming the glazing powder to be attached on the internal and external surfaces of the tableware body by the hydraulic moulding machine, to form glazing powder layers.
